(19) United States
(12) Patent Application Publication
(10) Pub. No.: US 2007/0251654 A1
(43) Pub. Date: Nov. 1, 2007

(54) Garage door hinge device

(76) Inventor: Andrew Liu, Richardson, TX (US)

Correspondence Address: Wilson Daniel Swayze, Jr., 3804 Clearwater Ct., Plano, TX, 75025, US

(21) Appl. No.: 11/365,387

(22) Filed: Mar. 1, 2006

(51) Int. Cl. E06B 3/48

(52) U.S. Cl. 160/229.1

(57) ABSTRACT

A garage door hinge device for mounting on a garage door includes a first mounting hinge bracket for connection to a first section of the garage door, a first bracket to be detachedly connected to the first mounting hinge bracket, a second mounting hinge bracket connected to a second section of the garage door, a second bracket being connected to a second section of the garage door. The first section of the garage door is separable from the second section of the garage door.

### FIELD OF THE INVENTION

The present invention relates to garage doors and more particularly to garage doors that are of the type that are movable from a lowered vertical position to a raised horizontal position.

### BACKGROUND OF THE INVENTION

U.S. Pat. No. 3,467,983 shows an overhead garage door hinge for an overhead door of the type movable from a lower vertical position to a raised horizontally position and includes upper and lower upstanding guide and hinge arms.

U.S. Pat. No. 5,921,307 discloses a door having a hinge bracket mounted on one panel and a hinge brace mounted on an adjacent panel. The bracket and brace are configured for gradually closing the gap between the edge walls so that as the edge walls slide by one another, pinching is prevented in the juncture.

There are many uses for a garage today. The obvious use is for the storage of automobiles and other items. However, an increasing number of people are using the garage area as a play area for children. With the garage door closed, there is little chance that small children can leave the garage area and wander into a street. Additionally, there are few items in the garage or no items that the children can damage especially if the automobiles are removed. Consequently, the number of activities which children can play in the garage is numerous. There is a problem with allowing children to play in the garage, especially in the areas of the country that have warmer temperatures. During the summertime, the temperature in a garage can rise quickly to the point where it is impossible for children to play in the garage. The higher temperatures cause people to look for ways to cool the garage even without the need for children to play the garage. One way to cool the garage is to leave the garage door open. However, leaving the garage door open presents a security risk, allowing the possibility for someone to enter the garage and remove valuable tools and other articles found in the garage.

One solution to this problem is to open the garage door partially allowing a significant open space between the bottom of the garage door and the floor of the garage to allow cooler air to enter the garage. However, a partially open garage door presents a serious security problem. Not only can children easily leave the garage area, thieves can easily enter the garage and steal valuable property such as tools and lawn equipment. Furthermore, small animals may wander into the garage. What is needed is a way to keep the garage door closed and supply air to cool the garage during the summer months. This should be accomplished without removing the standard garage doors and replacing the garage doors with a specialty door.

Standard garage doors usually include longitudinal garage door sections which run the entire length of an opening to the garage. The garage door sections have a relatively narrow width so that each garage door section can be rotated approximately 90° in a relatively short radius, and these garage door sections are connected with hinges so that the hinges and correspondingly the garage door sections pivot with respect to each other.

### SUMMARY

The present invention solves the above-mentioned problem by allowing the garage door to be closed at the bottom of the opening and open at the top of the opening so that the garage area receives fresh air to cool the garage. In addition, security concerns are met by the garage door being closed at the bottom. More particularly, children cannot get out side from the garage area with the bottom of the garage opening being blocked with the garage door.

In addition, the present invention deters theft because the access to the garage is restricted by the garage opening being closed at the bottom and prevents small animals from entering the garage.

The present invention employs an improved hinge for the garage door. More particularly, the present invention discloses a detachable connected mounting hinge bracket which can be separated so that at least one section of the garage door can remain in the raised open position while the remaining sections of the garage door are in the lowered closed position. This closes the garage opening at the bottom of the garage opening while leaving the top of the garage opening open to allow fresh air to enter the garage.

### DETAILED DESCRIPTION OF THE DRAWINGS

The invention may be understood by reference to the following description taken in conjunction with the accompanying drawings, in which, like reference numerals identify like elements, and in which:

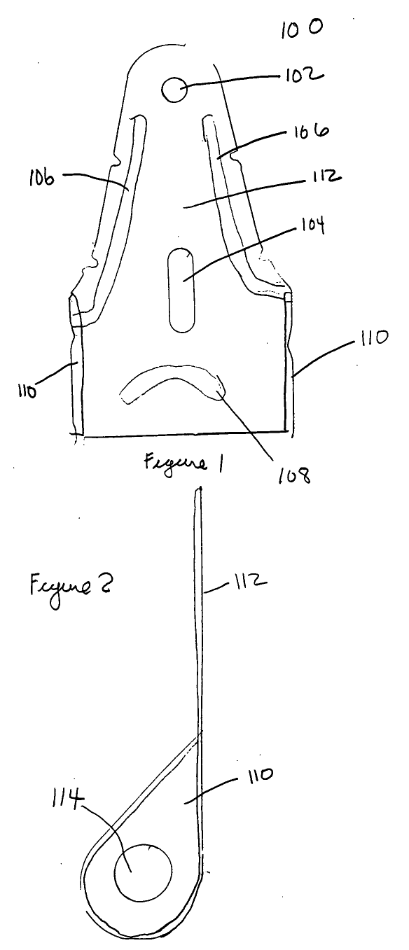

FIG. 1 illustrates cross-sectional view of a mounting hinge bracket of the present invention;

FIG. 2 illustrates a side view of the mounting hinge bracket of the present invention

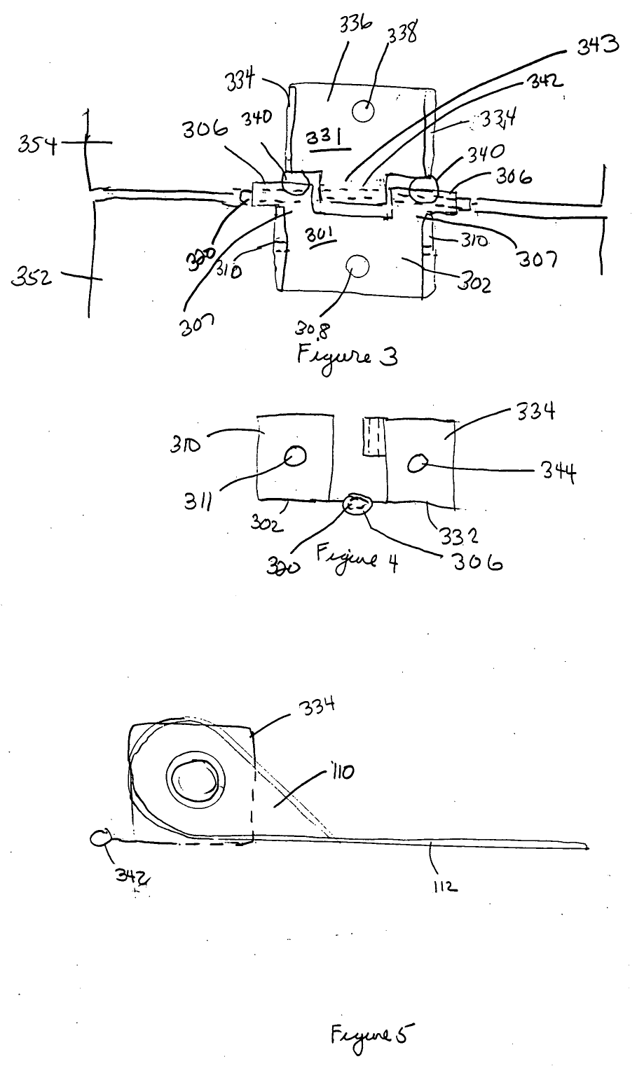

FIG. 3 illustrates a cross-sectional view of a first and second U-shaped brackets of the present invention;

FIG. 4 illustrates a side view of the first and second U-shaped brackets of the present invention;

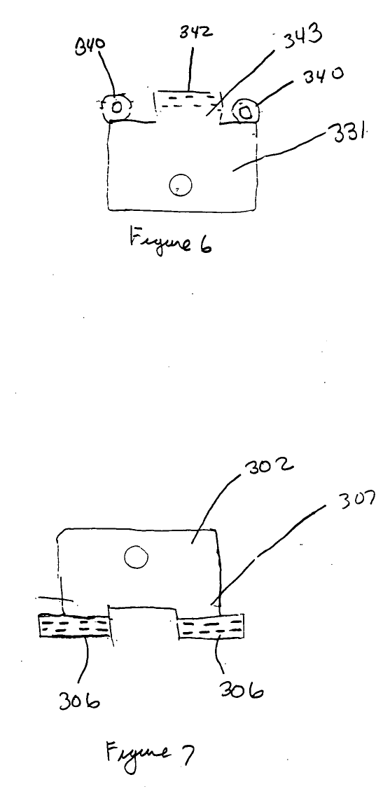

FIG. 5 illustrates a side view of the hinge bracket and the first U-shaped bracket of the present invention;

FIG. 6 illustrates the cross-sectional view of the second U-shaped bracket;

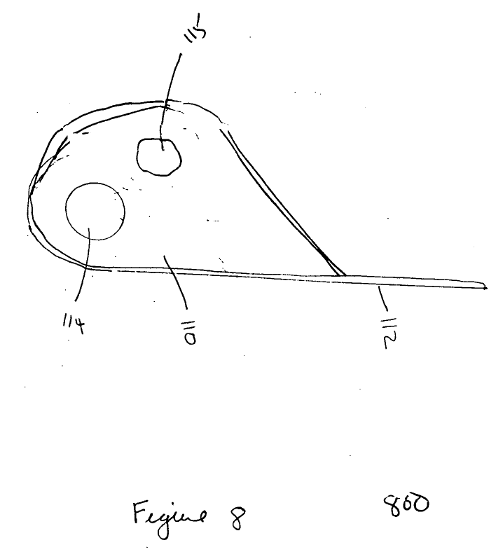

FIG. 7 illustrates a cross-sectional view of the first U-shaped bracket;

FIG. 8 illustrates another hinge bracket.

### DETAILED DESCRIPTION

FIG. 1 illustrates that the mounting hinge bracket 100 to be mounted on the garage door includes a bottom hinge section 112 for attachment to a garage door. The mounting hinge bracket 100 is formed from a rigid material such as steel or any other appropriate material. The mounting hinge bracket 100 may be connected to either the first U-shaped bracket 301 or the second U-shaped bracket 331. The mounting hinge bracket 100 includes a first raised portion 106 to add strength to the mounting hinge bracket 100 and a second raised portion 108 again to add strength to the mounting hinge bracket 100. The hinge bracket 100 additionally includes a first hole 102 so that the hinge bracket 100 can be fastened to the garage door and a second hole 104 so that of the mounting hinge bracket 100 can be fastened to the garage door. Although FIG. 1 shows one mounting hinge bracket 100, it is within the scope of the present invention that two or more mounting hinge brackets 100 may be used on different sections of the garage door and may be used in an opposing position. The mounting hinge bracket 100 further includes a side hinge section 110 for connection to either the first U-shaped bracket 301 or the second U-shaped bracket 331 so that the side hinge section 110 is detachably connected or alternatively permanently connected to either the first U-shaped bracket 301 or the second U-shaped bracket 331. The side hinge section 110 may be formed by bending the mounting hinge bracket 100 or any other suitable method. In one embodiment of the invention, each of the first U-shaped bracket 301 and the second U-shaped bracket 331 are connected to a separate hinge bracket 100. One hinge bracket 100 may be detachedly connected to the first or second U-shaped bracket 301, 331 and the other hinge bracket 100 may be permanently connected to the first or second U-shaped bracket 301, 331. In another embodiment, the other hinge bracket 100 is detachedly connected to both the first and the second U-shaped bracket 301, 331.

FIG. 2 illustrates a side view of the hinge bracket 100 showing the bottom hinge section and 112 and the side hinge section 110. The side hinge section 110 includes a hole 114 for accepting a pin to connect to the first or second U-shaped bracket 301.

FIG. 3 illustrates the first U-shaped bracket 301 connected to the second U-shaped bracket 331 by a pin 320 so that the first U-shaped bracket 301 can rotate with respect to the second U-shaped bracket 331.

FIG. 3 illustrates the first U-shaped bracket 301 mounted on a first garage door section 352 of a garage door and coupled to the second U-shaped bracket 331 mounted on a second garage door section 354 of the garage door. The first bottom section 302 of the first U-shaped bracket 301 is rotatable coupled to the second bottom section 332 of the second U-shaped bracket 331. The second bottom section 332 includes a center cylinder 342 to cooperate with each of the end cylinders 306 of the first bottom section 302. The center cylinder 342 is aligned with the end cylinders 306 so that a pin 320 may be inserted through the center cylinder 302 and through the end cylinder 306 so that the first U-shaped bracket 301 can rotate with respect to the second U-shaped bracket 331 by rotating around the pin 320. Consequently, the first garage door section 352 can rotate with respect to the second garage door section 354 and the garage door can be raised and lowered. The center cylinder 342 is connected to a center arm 343 which extends from the second bottom section 336 of the second U-shaped bracket 331, and the end cylinder 306 is connected to an end arm 307 which extends from the first bottom section 302 of the first U-shaped bracket 301. FIG. 3 additionally shows first side section 310 formed on each side and approximately perpendicular to the first bottom section 302. Correspondingly, FIG. 3 illustrates the second side section 334 formed on each side and approximately perpendicular to the second bottom section 302.

FIG. 3 additionally shows that the first bottom section 302 and the second bottom section 332 includes a first hole 308 and a second hole 338 respectively.

FIG. 4 illustrates a side view of the first U -shaped bracket 301 and the second U-shaped bracket 331. The first side section 310 includes a first hole 311 in each first side section 310 to cooperate with the hole 114 to accept a pin or axle so that the first U-shaped bracket 301 will rotate with respect to the hinge bracket 100. The second side section 334 of the second U-shaped bracket 331 includes a second hole 344 to cooperate with another hole 114 of another hinge bracket 100 to accept another pin or axle so that the second U-shaped bracket 331 will rotate with respect to the other hinge bracket 100.

FIG. 4 additionally shows the end cylinder 306 cooperating with the pin 320 said that the first U-shaped bracket 301 will rotate with respect to the second U-shaped bracket 331.

FIG. 5 shows the second side section 334 of the second U-shaped bracket 331 positioned adjacent to the side hinge section 110 with the second hole 344 aligned with the hole 114 of the hinge bracket 100 to accept a pin or axle. The pin or axle may permanently connect the second U-shaped bracket 331 adjacent to the side hinge section 110 or the pin or axle may be detachedly connected to the second U-shaped bracket 331 in the side hinge section 110.

FIG. 6 illustrates the second U-shaped bracket 331 including the center cylinder 342 which is positioned on the center arm 343 and cylinders 340 positioned approximately perpendicular to the center cylinder 342.

FIG. 7 illustrates the first U-shaped bracket 302 including the end cylinders 306 which are positioned on the end arm 307.

FIG. 8 illustrates an additional mounting hinge bracket 800 including a hole 115 for placement of a axle for a wheel to be mounted in a guide track to guide the panels of the garage door. The first garage door section 352 is separated from the second garage door section 354 by removing the pin or axle from the hole 114 of the mounting hinge bracket 100 which is attached to the second garage door section 354. Now, the second garage door section 354 and the mounting hinge bracket of 100 attached to the second garage door section 354 is free to travel to the raised horizontal open position. The first garage door section 352 remains in the lower vertical closed position with the mounting hinge bracket 100 attached to the first garage door section of 352, the first U-shaped bracket 301 and the second U-shaped bracket 331.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A garage door hinge device for mounting on a garage door, comprising:
a first mounting hinge bracket for connection to a first section of said garage door;
a first bracket to be detachedly connected to said first mounting hinge bracket;
a second mounting hinge bracket connected to a second section of said garage door;
a second bracket being connected to a second section of said garage door;
wherein said first section of said garage door is separable from said second section of said garage door.

2) A garage door hinge device for mounting on a garage door as in claim 1, wherein said first bracket rotates with respect to said second bracket.

3) A garage door hinge device for mounting on a garage door as in claim 1, wherein said first bracket is substantially U-shaped.

4) A garage door hinge device for mounting on a garage door as in claim 1, wherein said second bracket is substantially U-shaped.

5) A garage door hinge device for mounting on a garage door as in claim 1, wherein said first bracket rotates with respect to said mounting hinge bracket.

6) A garage door hinge device for mounting on a garage door as in claim 1, wherein said second bracket rotates with respect to said second mounting hinge bracket.

7) A garage door hinge device for mounting on a garage door as in claim 1, wherein said first bracket includes a first cylinder.

8) A garage door hinge device for mounting on a garage door as in claim 7, wherein said second bracket includes a second cylinder.

9) A garage door hinge device for mounting on a garage door as in claim 8, wherein said first cylinder cooperates with said second cylinder to rotate said first bracket with respect to said second bracket.

10) A garage door, comprising:
said garage door including a first section and a second section;
a first mounting hinge bracket for connection to said first section of said garage door;
a first bracket to be detachedly connected to said first mounting hinge bracket;
a second mounting hinge bracket connected to said second section of said garage door;
a second bracket being connected to a second section of said garage door;
wherein said first section of said garage door is separable from said second section of said garage door.

11) A garage door as in claim 10, wherein said first bracket rotates with respect to said second bracket.

12) A garage door as in claim 10, wherein said first bracket is substantially U-shaped.

13) A garage door as in claim 10, wherein said second bracket is substantially U-shaped.

14) A garage door as in claim 10, wherein said first bracket rotates with respect to said mounting hinge bracket.

15) A garage door as in claim 10, wherein said second bracket rotates with respect to said second mounting hinge bracket.

16) A garage door as in claim 10, wherein said first bracket includes a first cylinder.

17) A garage door as in claim 16, wherein said second bracket includes a second cylinder.

18) A garage door as in claim 18, wherein said first cylinder cooperates with said second cylinder to rotate said first bracket with respect to said second bracket.
